(19) United States
(12) Patent Application Publication
(10) Pub. No.: US 2024/0089360 A1
(43) Pub. Date: Mar. 14, 2024

(54) ANALOG GAMING CASE FOR MOBILE ELECTRONIC DEVICES

(71) Applicant: Ellen Samantha Brown, Philadelphia, PA (US)

(72) Inventor: Ellen Samantha Brown, Philadelphia, PA (US)

(21) Appl. No.: 17/931,388

(22) Filed: Sep. 12, 2022

(51) Int. Cl. H04M 1/21; A63F 9/00; H04B 1/3888; H04M 1/04

(52) U.S. Cl. CPC H04M 1/21; A63F 9/001; H04B 1/3888; H04M 1/04

(57) ABSTRACT

Embodiments of phone or tablet cases are disclosed herein. The embodiments enable a user to entertain themselves if phone or tablet dies by providing a non-electronic game on the backside of the case. Various forms of games are disclosed and configured in novel ways that enable their use on a phone case.

### BACKGROUND OF THE INVENTION

The present invention relates to phone cases and, more particularly, to a phone case with an integrated non-electronic game

Smartphones and tablets/iPads™ are the primary source of entertainment for many individuals. If the phone or tablet dies due to running out of battery charge, so does their entertainment. Electronics, as a whole, are becoming a primary source of entertainment. If an electronic device runs out of electricity and there is no way to charge it (e.g., a user doesn't have a power cable or there isn't an electronic source), a user is left without an effective source of entertainment.

As can be seen, there is a need for a phone case with an integrated non-electronic game.

### SUMMARY OF THE INVENTION

In one aspect of the present invention, a phone case includes: a phone case body; and a non-electronic game directly integrated with the phone case body.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a block diagram of the present invention;

FIG. 2 is a perspective view of a first configuration of the present invention;

FIG. 3 is an exploded perspective view of the first configuration;

FIG. 4 is a perspective view of a second configuration of the present invention;

FIG. 5 is a perspective view of a third configuration of the present invention;

FIG. 6 is a perspective view of a fourth configuration of the present invention;

FIG. 7 is a perspective view of a fifth configuration of the present invention; and

FIG. 8 is a perspective view of a sixth configuration of the present invention.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured.

Broadly, one embodiment of the present invention is a phone case that includes a non-electronic game on a side opposite the receiving portion

The present invention enables a user to entertain themselves and others without the use of electricity. Most phone cases do not include games. The ones that do, require electricity. The present invention breaks that cycle by allowing a user to play all day without electricity.

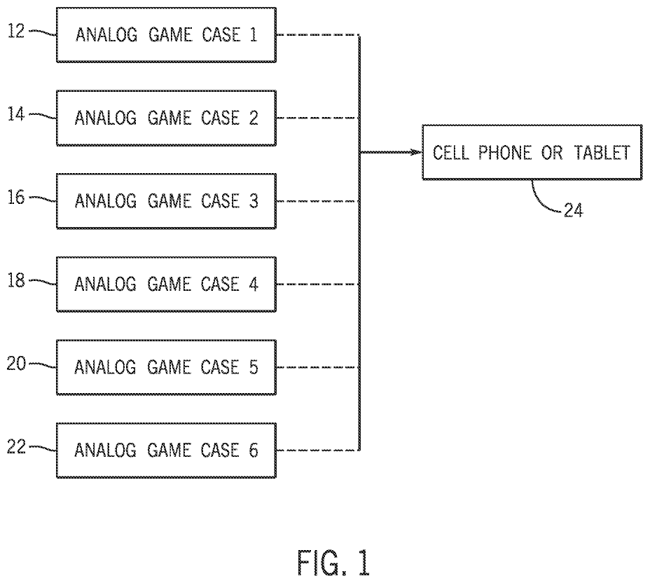

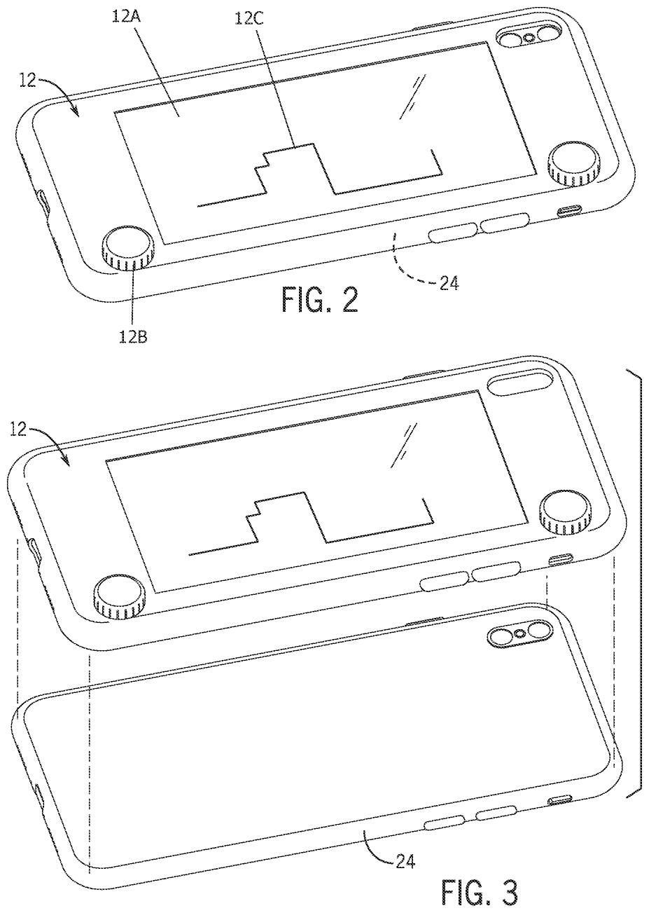

Referring now to FIG. 1, the present invention includes a number of configurations of game phone cases 12, 14, 16, 18, 20, 22 that can be secured to a cell phone 24 or tablet 24 in the same manner a conventional case is secured to a phone 24 or tablet 24. FIGS. 2 and 3 illustrate how the phone 24 can be secured in a respective game case 12. The following are all non-electronic game cases that an individual can use on any phone or tablet (e.g., an iPad™) without the use of electricity. Certain games, where referenced, are depicted in the appended drawings.

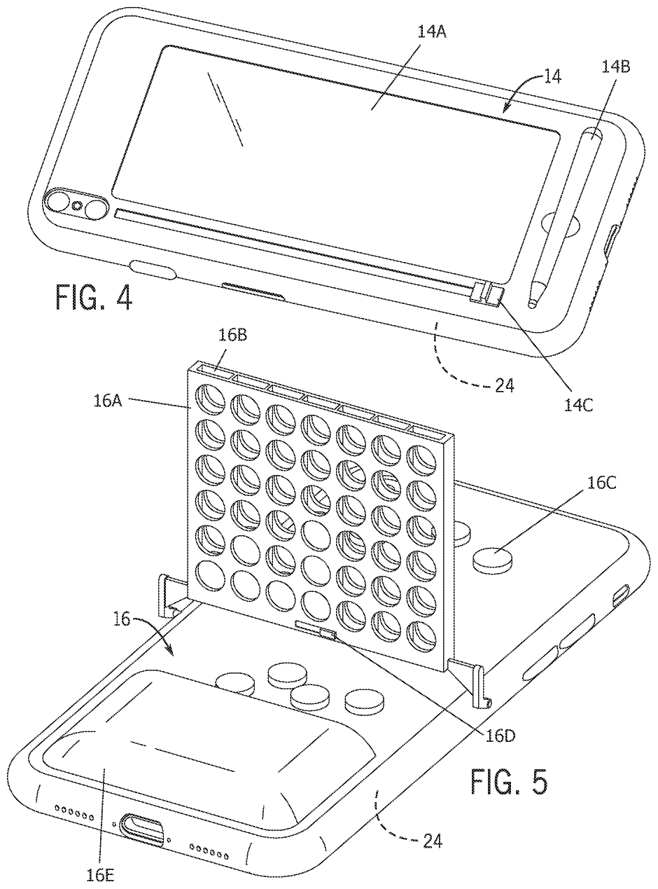

A first game disclosed is colloquially known as “Play Sketch” and is generally depicted in FIG. 4. This game case 14 allows an individual to draw on an non-electronic screen 14A freely with the use of a pen 14B. Drawings can be erased using a slider eraser 14C.

A second game disclosed is colloquially known as “Fun Sketch” and is generally depicted in FIGS. 2 and 3. This game case 12 allows an individual to draw or sketch on a non-digital screen 12A using two dials 12B that can be twisted to create and move a line on the screen 12A.

A third game disclosed is colloquially known as “Xylo Fone” and generally depicted in FIG. 6. This game case 18 allows an individual to play music without the use of electricity. They can use mallets 18A or their finger to hit tone bars 18B provided on the case 18 to create sounds thereon. The mallets can be clipped onto sides of the case 18.

A fourth game disclosed is colloquially known as “Arcade Fun.” This game case is similar to a pinball game. An individual just needs to pull the plunger back and shoot one of the plastic or steel balls up the chute and see where it lands. The goal is to land on the highest number.

A fifth game is disclosed that is colloquially known as “Guitar Fun.” This game case allows an individual to play music without the use of electricity. They simply use the strum provided or their finger to create beautiful sounds.

A sixth game is disclosed that is colloquially known as “Accordion Fun.” This game case allows a user to play music without the use of electricity. They simply stretch the accordion in and out to create beautiful sounds.

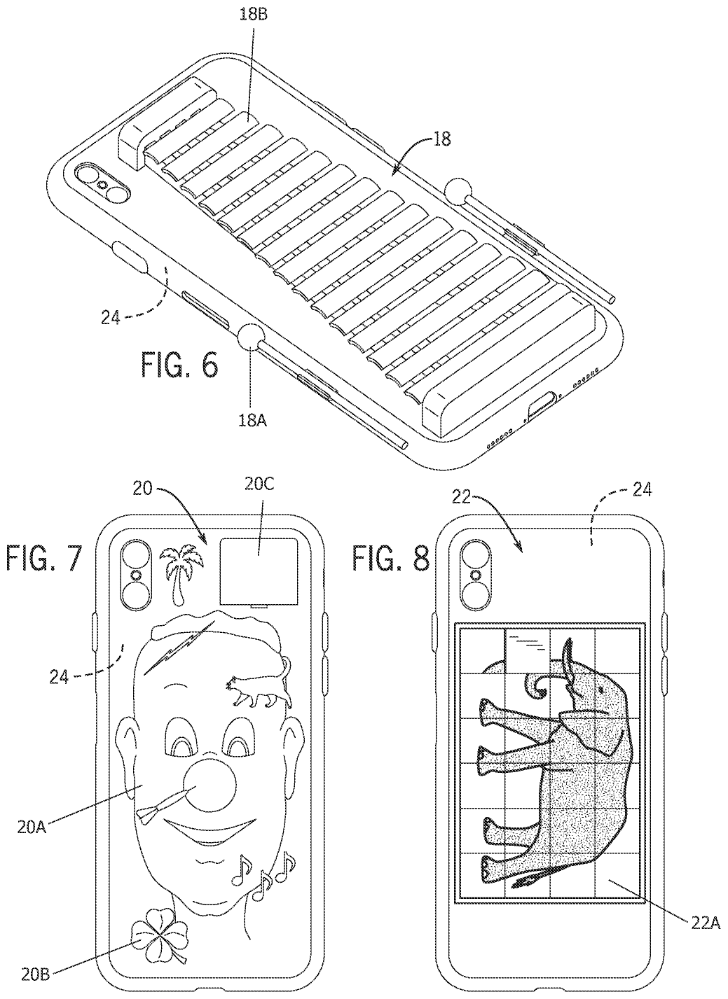

A seventh game is disclosed that is colloquially known as “Face Makeover” and is generally depicted in FIG. 7. This is game case that an individual can use to play a game with another person or by themselves. There are five or six areas on the face 20A to fix. The individual would take tweezers to remove these items from the face 20A. In doing so, they must try not touch the sides or the bottom.

An eighth game is disclosed that is colloquially known as “Fone Connect” and generally depicted in FIG. 5. This game case 16 allows a user to play by themselves or with a friend. A game apparatus 16A includes a plurality of slots 16B in which a plurality of colored pieces 16C are inserted. To begin play, the game apparatus is slid or rotated upwards. Use the different colored pieces 16C provided, a player tries to get four of the same-colored pieces 16C in a row within the game apparatus 16A. At the conclusion of the game, a tab 16D can be manipulated to release the game pieces 16C at a bottom side of the game apparatus 16A. The game pieces 16C can be retained in a pocket 16E provided on the case 16.

A ninth game is disclosed that is colloquially known as “Fun Tac Toe.” This game case allows you to play without the use of electricity. Using the nine squares provided, a user tries to get three marks in a row. They can play with a friend or by themselves.

A tenth game is disclosed that is colloquially known as “Hero Man.” This game case allows a user to play without the use of electricity. Using the layout provided, they try and guess their friends' words with a limited amount of tries using a writing utensil. If they guess wrong, they start filling in the superhero. If they lose, you will see a completed superhero ready to save them.

An eleventh game is disclosed that is colloquially known as “What's the picture?” and is generally depicted in FIG. 8. This game case 22 allows you to play without the use of electricity. Using the squares 22A provided, a user tries to arrange the smaller pieces of the squares to complete a proper picture of something (e.g., an elephant, as shown in FIG. 8).

A twelfth game is disclosed that is colloquially known as “Fun Maze.” This game case allows a user to play without the use of electricity. To play, they to navigate through the maze using the game board and/or pieces provided.

A thirteenth game is disclosed that is colloquially known as “Wheel of Fun.” This game case allows a user to play without the use of electricity. They spin the wheel and whatever task it lands on, complete it accordingly.

A fourteenth game is disclosed that is colloquially known as “Fone Fun Checkers/Chess.” This game case allows you to play without the use of electricity and is similar to the original game of checkers and chess. Using the pieces provided, a player tries to win this historic game.

A fifteenth game is disclosed that is colloquially known as “Glow Phone.” This game case allows a player to play without the use of electricity. In use, a player uses the casing to help mold glow goo together. Alternatively, they can take the goo out and play with a friend.

As those with skill in the art will appreciate, all the previously described embodiments allow a user to entertain themselves and others via hand games and without the need for electricity. If a user's electronic device dies, they can simply flip the device over and play an embodiment of the present invention. While not a problem exclusive to this category, the loss of power of an electronics device can be especially challenging for children and adults (and parents with children) who have attention deficit hyperactivity disorder (ADHD). The present invention is particularly advantageous for that subset of individuals. Further, children who are autistic or have other behavioral or learning challenges could also benefit from a phone case in accordance with the present invention. The games provided on these cases challenge the mind and teach patience, and could have a positive impact on millions of lives.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. The term “substantially” shall be interpreted to mean completely and/or nearly completely. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A phone case comprising:
a phone case body; and
a non-electronic game directly integrated with the phone case body.

2. The phone case of claim 1, wherein the non-electronic game comprises a non-electronic screen and two dials, the two dials being twistable to form a line on the non-digital screen.

3. The phone case of claim 1, wherein the non-electronic game comprises a non-electronic screen, a pen for writing on the non-electronic screen, and a slider eraser.

4. The phone case of claim 1, wherein the non-electronic game comprises:
an apparatus rotatably coupled to the phone case body and comprising a plurality of slots; and
a plurality of colored game pieces insertable into the plurality of slots.

5. The phone case of claim 4, wherein the phone case body comprises a pocket for receiving the plurality of colored game pieces.

6. The phone case of claim 1, wherein the non-electronic game comprises a plurality of tone bars and one or more mallets clipably coupled to the phone case body.

7. The phone case of claim 1, wherein the non-electronic game comprises a face with a plurality of items placed thereon and tweezers configured to remove the plurality of items from the face.

8. The phone case of claim 1, wherein the non-electronic game comprises a plurality of squares that are slidably rearrangeable to form a picture when positioned in a particular manner.
